(19) United States
(12) Patent Application Publication
(10) Pub. No.: US 2005/0183919 A1
(43) Pub. Date: Aug. 25, 2005

(54) Gearshift clutch

(76) Inventor: Rudolf Folk, Burghaslach (DE)

Correspondence Address: HEDMAN & COSTIGAN P.C., 1185 AVENUE OF THE AMERICAS, NEW YORK, NY, 10036, US

(21) Appl. No.: 11/029,791

(22) Filed: Jan. 4, 2005

Related U.S. Application Data
(63) Continuation of application No. PCT/EP03/06870, filed on Jun. 28, 2003.

(30) Foreign Application Priority Data
Jul. 5, 2002 (DE) DE 102 30 189.1

(51) Int. Cl. F16D 23/02

(52) U.S. Cl. 192/48.91; 192/53.32; 192/53.34; 192/107 M

(57) ABSTRACT

A gearshift clutch in a manual transmission for selection of at least one gearwheel, said gearshift clutch comprising at least one clutch element that is rotatable about an axis of rotation of the gearshift clutch, which clutch element, for transmitting torques about the axis of rotation, meshes at least temporarily and at least partially through at least one first tooth profile made of a metallic material with at least one second tooth profile made of a metallic material within the gearshift clutch, one of said first and second meshing tooth profiles being temporarily displaceable parallel to the axis of rotation in the other of said first and second meshing tooth profiles, so that friction occurs between said first and second meshing tooth profiles, wherein at least the first tooth profile comprises a sliding coating on a surface of the metallic material for reducing friction.

### FIELD OF THE INVENTION

The invention concerns a gearshift clutch in a manual transmission for selection of at least one gearwheel, said gearshift clutch comprising at least one clutch element that is rotatable about an axis of rotation of the gearshift clutch, which clutch element, for transmitting torques about the axis of rotation, meshes at least temporarily and at least partially through at least one first tooth profile made of a metallic material with at least one second tooth profile made of a metallic material within the gearshift clutch, one of said first and second meshing tooth profiles being temporarily displaceable parallel to the axis of rotation in the other of said first and second meshing tooth profiles, so that friction occurs between said first and second meshing tooth profiles.

### BACKGROUND OF THE INVENTION

Gearshift clutches of the pre-cited type are the known selector sleeve or dog clutches with which, for selecting gears in manual transmissions, one gearwheel, but preferably two gearwheels can be selectively engaged. A separable positive connection is established with gearshift clutches as a rule between a transmission shaft and the selected gearwheel. Through this connection, torques resulting from the power flow in the transmission are transmitted from the transmission shaft to the gearwheel, or vice versa.

A common gearshift clutch of a generic type is described in DE 198 32 729 A1. For transmitting the torques, the individual clutch elements like the selector sleeve, the sleeve carrier and the clutch gearing on the gearwheel, engage positively with one another through gearings. The selector sleeve is seated either directly on the transmission shaft or, as is the case in DE 198 32 729 A1, on the sleeve carrier and is fixed in peripheral direction against rotation but can slide parallel to the axis of rotation of the gearshift clutch on the transmission shaft or the sleeve carrier. For this purpose, the selector sleeve engages through a tooth profile into a corresponding counter tooth profile on the transmission shaft or on the sleeve carrier. The flanks of the teeth of the tooth profiles extend parallel to the axis of rotation. For selection of a gear, the selector sleeve, permanently guided in the counter gearing on the sleeve carrier, moves parallel to the axis of rotation till the, or a further tooth profile on the selector sleeve meshes with the tooth profile of the clutch gearing. During the selection movement, frictional forces between the flanks of the teeth of the tooth profiles of the sleeve carrier and the selector sleeve that move against each other, and between the flanks of the tooth profiles of the selector sleeve and the clutch gearing that mesh with each other, have to be overcome. In the case of synchronized gearshift clutches, additional forces are produced by the friction on the sliding flanks of the selector sleeve and the locking gearing of the outer synchronizer ring when the tooth profile of the selector sleeve travels through a tooth profile of the locking gearing after synchronization. Particularly in the first hours of operation of new vehicles, the selection forces resulting from the friction are relatively high because the meshing clutch elements, or the clutch elements destined to be meshed with each other, have still to work in with each other. Gear shifting is often rough or sluggish at the beginning. The comfort of gear selection is diminished.

By gearings, tooth profiles and teeth are to be understood all elements such as wedge profiles, wedges, claws and serrations that are suited for forming permanent or separable positive connections for transmitting torques in gearshift clutches. Such tooth profiles and their teeth are generally made of iron or steel, for example of case-hardening steels, and are hardened at least on the surface.

### OBJECTS OF THE INVENTION

It is an object of the invention to provide a gearshift clutch with which the aforesaid drawbacks can be avoided. This applies in particular to the first hours of operation of new vehicles in which, in some cases, it is still hard to move the meshing mechanical parts against each other that therefore have to work in with each other first.

This and other objects and advantages of the invention will become obvious from the following detailed description.

### SUMMARY OF THE INVENTION

The invention achieves the above objects by the fact that at least one of the tooth profiles of the clutch elements in the gearshift clutch comprises a sliding coating on the surface of the metallic material for reducing friction. Such coatings are permanent or are configured for the run-in phase on at least one of the meshing tooth profiles or of the tooth profiles destined to mesh with each other. Such coatings also facilitate the running-in of the clutch elements that initially move only sluggishly on each other. Preferably both the tooth profiles that rub against each other are provided with a sliding coating of the same or of a different composition.

According to one feature of the invention, the sliding coating is a metal phosphate coating. Metal phosphate coatings are coatings that are deposited by phosphatizing methods on the base material at least on the gearing of the clutch elements, but preferably on the entire clutch element. Phosphatizing is a chemical/electrochemical method in which thin layers of fine- or coarse-grained and water-insoluble phosphates are deposited out of phosphoric acid solutions by immersion or spraying methods on metal surfaces. Because the metal phosphate coatings are produced by a chemical reaction with the base metal (iron or steel of the gearing), they are firmly anchored in the metal surface of the base metal and comprise a large number of voids and capillaries. This property imparts an optimal ability to the phosphate coatings to absorb oils and solid lubricant particles. Such coatings have proved to be effective as sliding coatings and connecting and carrier coatings. With a thickness of 2 μm to 15 μm (may also go up to about 20 μm), they are applied as an anticorrosive coating for transportation and storage, as a sliding coating and/or as an adhesive coating for further sliding coatings. They have a fine to coarse crystalline appearance (depending on the method) and impart to the material the ability to absorb oil and lubricants so that an efficient corrosion protection is guaranteed. They can be used on clutch elements comprising tooth profiles of iron or steel as a base material such as, for example, standard case-hardening steels made to DIN 17210, for instance, 16MnCr5, 20MnCr5, 15CrNi6, 18CrNi8, 41Cr4. The following coatings can be used:
Iron phosphate coating (FePh)
Zinc phosphate coating (ZnPh)
Zinc calcium phosphate coating (ZnCaPh)
Manganese phosphate coating (MnPh)
Zinc iron phosphate coating ((ZnFePh) or
Manganese iron phosphate coating (MnFePh).

Preferably used are manganese phosphate coatings. The process of phosphatizing itself can be followed by oiling with an emulsion. Such an oiling is sufficient for a short-term corrosion protection during transportation and storage of the clutch elements, so that an additional advantage is created.

Further features of the invention described below relate to possible alternatives to the aforesaid metal phosphate coatings as sliding coatings for use on tooth profiles:
Metal phosphate coatings as carrier and connecting coatings;
Metal phosphate coatings are also suitable for applying solid lubricants to tribologically loaded surfaces. The solid lubricants are included, for example in sliding coatings. These sliding coatings can be modified for the particular case of use and lubricate without a hydrodynamic film, protect from corrosion and possess a load-bearing ability. The mixture of solid lubricants including bonding agents is applied to the metal phosphate coating forming a carrier material. This carrier material has a layer thickness of 1 μm to 4 μm. The entire layer thickness of the carrier material together with the sliding layers lies preferably in a range of 5 μm to 10 μm. The solid lubricants used are normally MoS₂, graphite and PTFE or mixtures of these. In applications for extremely high loading, carbides are also used.
PTFE;
Polytetrafluor ethylene ranges among the substances having the lowest friction and a high chemical stability whose coatings possess uniform friction characteristics at a very low level of friction. An additional advantage of PTFE coatings or coatings containing PTFE is that PTFE particles separated from the composite material get seized in the pores of the, for instance, not coated counter friction surface where they likewise form a lubricant film. Depending on the use, PTFE coatings have a layer thickness of 15 μm to 100 μm and can also be deposited as sliding coatings on the carrier material of a metal phosphate layer.
Graphite;
Graphite is either added to lubricating oils and subsides into the pores of the metal or the phosphate sliding coating as provided by the invention, or it is used in carbon-containing sliding coatings, for example, by admixture of carbon fibers interspersed with graphite, with a layer thickness of, for example, 1 μm to 4 μm on the base metal of the gearing or on the metal phosphate carrier coating. Graphite has a positive effect on the friction behavior and improves the aforesaid running-in behavior.
Plastic-based sliding coatings containing graphite;
Sliding films of carbon-based hard coatings;
The carbon-based hard coating is applied to the base material of the tooth profile. The main constituent of carbon-based hard coatings is carbon, for example, amorphous carbon (aC), hydrogenous carbon (aC:H), i-carbon (iC) or adamantine carbon (DLC). These coatings are generally deposited by plasma-reinforced chemical precipitation.
Multi-layer coating systems with carbon-containing sliding coatings;
Multi-layer coating systems with carbon-containing sliding coatings on a group of layers comprising at least one appropriate carbon-containing sliding layer and a carrier layer on an adhesive layer connected to the metallic base material. The adhesive and the carrier layer may be the aforesaid metal phosphate coating or specially adapted layers of other materials.
MoS₂
As an anti-friction additive, molybdenum disulphide can be added to the lubricating oil and sinks into the pores of the sliding coating or it can be applied as a separate sliding coating e.g. by means of a sliding lacquer or as a hot-hardening layer on the metal phosphate layer configured as a carrier layer, or directly on the surface of the base metal of the tooth profile. In the latter case, for example, MoS₂ is a constituent of sliding lacquers.
Chrome coatings;
The structure and the adhesive friction behavior of chrome coatings remains neutral up to high temperature ranges. Advantageously, these coatings are provided on both friction members. In this way, the coefficient of friction between the friction coatings of chrome (preferably 99% chrome content) is considerably reduced. The coating thicknesses are situated in a range of 1 μm to 10 μm. The chrome coatings form molecular compounds with the base metal that are hardly susceptible to destruction even under severe loads. They therefore also constitute a very good wear protection.
Electrolytically deposited silver coatings;
Electrolytically deposited silver coatings possess good lubricating properties. In particular, at high temperatures of operation in the manual transmission, silver coatings are a good alternative to the aforesaid lubricating coatings containing solids.
Chemical nickel;
Nickel coatings together with hard or solid materials like silicon carbide, PTFE or diamonds.

Depending on their composition and individual constituents, the aforesaid coatings are applied by the most different of methods. The following methods may be mentioned by way of example: the so-called drying-on method, galvano-electrolytic, chemico-autocatalytic, or chemical deposition without external current, by cathodic sputtering, thermal methods, by spraying, spraying with laser beam, molten bath spraying, powder flame or wire flame spraying, arc or plasma spraying, vapor deposition (e.g. in vacuum), dipping methods, varnishing, (e.g. wet varnishing).

According to further propositions of the invention, at least the tooth profile of the selector sleeve comprises the sliding coating of the invention.

The selector sleeve is preferably seated on a selector sleeve carrier, or directly on a transmission shaft and meshes through the coated tooth profile either with a tooth profile of the sleeve carrier or of the transmission shaft. A further clutch element is the sleeve carrier whose tooth profile oriented toward the selector sleeve likewise comprises a sliding coating. Preferably, both the tooth profile of the selector sleeve and the tooth profile of the sleeve carrier that mesh with each other comprise sliding coatings of the same or of different chemical composition. According to a further feature of the invention, the tooth profile of the clutch gearing likewise comprises a sliding coating. Also included are selector sleeves that comprise more than one of the mentioned tooth profiles, for example, one tooth profile for meshing with the selector sleeve carrier and a further tooth profile for meshing with the clutch gearing. Preferably, both the tooth profiles of the selector sleeve comprise a sliding coating.

### BRIEF DESCRIPTION OF THE DRAWINGS

FIG. 1 shows a gearshift clutch in which the individual tooth profiles of the different clutch elements comprise a sliding coating of the invention.

FIGS. 2 to 5 show examples of embodiment of the individual clutch elements of the gearshift clutch of FIG. 1.

### DETAILED DESCRIPTION OF THE DRAWINGS

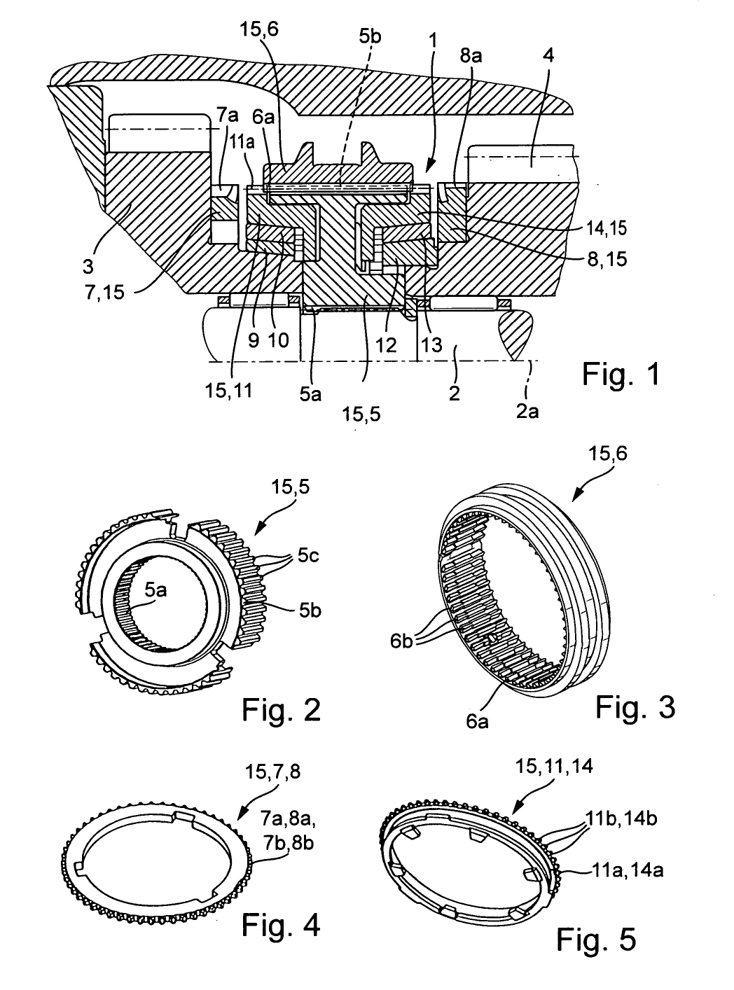

FIG. 1 shows a gearshift clutch 1 in a manual transmission, not shown in detail. Through the gearshift clutch 1, a transmission shaft 2 can be selectively coupled rotationally fast to a gearwheel 3 or a gearwheel 4. The gearshift clutch 1 comprises the clutch elements 15 in the form of a sleeve carrier 5, a selector sleeve 6 and clutch plates 7 and 8. The sleeve carrier 5 comprises a gearing 5a that is oriented radially inwards towards the axis of rotation 2a of the transmission shaft 2 or the gearshift clutch 1. Through the gearing 5a, the sleeve carrier 5 is fixed in rotation to the transmission shaft. The clutch plates 7 and 8 are firmly connected respectively to the gearwheels 3 and 4. The selector sleeve 6 is seated on the sleeve carrier 5 and meshes through a tooth profile 6a with a corresponding tooth profile 5b of the sleeve carrier 5. The tooth flanks of the meshing teeth 5c and 6b of the tooth profiles 5b and 6a (FIGS. 2, 3) are oriented parallel to the axis of rotation 2a. The selector sleeve 6 can be displaced parallel to the axis of rotation 2a selectively toward one of the gearwheels 3 or 4 and finally meshes with one of the tooth profiles 7b and 8b of the clutch gearings 7a and 8a on the clutch plates 7 and 8, respectively. Through a simultaneous meshing of the tooth profile 6a with the tooth profile 5b and the tooth profile 7b or 8b, a torque-transmitting connection can be established between the transmission shaft 2 and one of the gearwheels 3, 4.

A synchronizer device integrated in the gearshift clutch 1 comprises synchronizer rings 9, 10, 11 and 12, 13, 14, that adjoin the sleeve carrier 5 along the axis of rotation 2a. The outer synchronizer rings 11 and 14 comprise respective tooth profiles 11a and 14a whose locking teeth 11b and 14b unblock the movement of the selector sleeve 6 along the axis of rotation 2a after synchronization. The tooth profile 6a of the selector sleeve travels through the tooth profile 11a or 14a of the outer synchronizer ring 11 or 14, as the case may be.

FIG. 2 shows an example of embodiment of the sleeve carrier 5 in an overall view with the individual teeth 5c of the tooth profile 5b. According to the invention, the entire surface of the sleeve carrier 5 including the tooth profile 5b, comprises a sliding coating. FIG. 3 shows an example of embodiment of the selector sleeve 6 in an overall view with the individual teeth 6b of the tooth profile 6a. According to the invention, the entire surface of the selector sleeve including the tooth profile 6a, comprises a sliding coating. FIG. 4 shows an embodiment of the clutch plates 7 and 8 of the clutch gearings 7a and 8a with the tooth profiles 7b and 8b. The clutch plates 7 and 8 comprise a sliding coating. FIG. 5 shows an example of embodiment of the outer synchronizer rings 11 and 14 with the individual teeth 11b and 14b of the tooth profiles 11a and 14a. According to the invention, each of the tooth profiles 11a and 14a comprises a sliding coating.

1. A gearshift clutch in a manual transmission for selection of at least one gearwheel, said gearshift clutch comprising at least one clutch element that is rotatable about an axis of rotation of the gearshift clutch, which clutch element, for transmitting torques about the axis of rotation, meshes at least temporarily and at least partially through at least one first tooth profile made of a metallic material with at least one second tooth profile made of a metallic material within the gearshift clutch, one of said first and second meshing tooth profiles being temporarily displaceable parallel to the axis of rotation in the other of said first and second meshing tooth profiles, so that friction occurs between said first and second meshing tooth profiles, wherein at least the first tooth profile comprises a sliding coating on a surface of the metallic material for reducing friction.

2. A gearshift clutch of claim 1, wherein both the first tooth profile and the second tooth profile comprise a sliding coating.

3. A gearshift clutch of claim 1, wherein the sliding coating is a metal phosphate coating.

4. A gearshift clutch of claim 1, wherein the clutch element is a selector sleeve that is coupled to a transmission shaft for rotating about the axis of rotation, the transmission shaft can be coupled through the selector sleeve rotationally fast to a gearwheel, and the selector sleeve comprises the first tooth profile.

5. A gearshift clutch of claim 1, wherein the gearshift clutch comprises at least a first and a second clutch element, the first clutch element is a sleeve carrier that can rotate together with a transmission shaft about the axis of rotation and comprises the second tooth profile, and the second clutch element is a selector sleeve that is seated on the sleeve carrier and comprises the first tooth profile that meshes at least partially with the second tooth profile.

6. A gearshift clutch of claim 1, wherein each of the first and the second tooth profiles comprises a sliding coating.

7. A gearshift clutch of claim 1, wherein the gearshift clutch comprises at least a first, a second and a third clutch element, the first clutch element is a sleeve carrier that can rotate together with a transmission shaft about the axis of rotation and comprises the second tooth profile, the second clutch element is a selector sleeve that is seated on the sleeve carrier and comprises the first tooth profile that meshes at least partially with the second tooth profile, and the third clutch element is a clutch gearing that is coupled rotationally fast to the gearwheel and comprises a third tooth profile, the first tooth profile meshes at least temporarily and simultaneously with the second tooth profile and with the third tooth profile, so that the gearwheel is coupled rotationally fast to the transmission shaft.

8. A gearshift clutch of claim 7, wherein each of the first, the second and the third tooth profiles comprises a sliding coating.
